(19) United States
(12) Patent Application Publication
(10) Pub. No.: US 2022/0009277 A1
(43) Pub. Date: Jan. 13, 2022

(54) PAINT STIR SPATULA

(71) Applicant: MRM sales inc, Nesconset, NY (US)

(72) Inventor: Lawrence F. Scarpati, Lakewood, NJ (US)

(73) Assignee: MRM sales inc, Nesconset, NY (US)

(21) Appl. No.: 17/371,666

(22) Filed: Jul. 9, 2021

Related U.S. Application Data
(60) Provisional application No. 63/049,730, filed on Jul. 9, 2020.

(51) Int. Cl. B44D 3/10; A46B 17/06; B08B 1/00; B01F 13/00; B44D 3/16

(52) U.S. Cl. CPC B44D 3/105; A46B 17/06; B08B 1/005; B01F 2215/005; B44D 3/164; A46B 2200/202; B01F 13/002

(57) ABSTRACT

A multi-function paint stir spatula has a beveled putty knife at one end of the spatula for applying putty and/or scraping dry paint, one or two indentations along one or both edges of the spatula that define a straight squeegee between each indentation and the other end of the spatula for scraping wet paint from the inside wall of a can of paint, a curved, roller squeegee indentation on one edge of the spatula for scraping wet paint from a paint roller, and a serrated, brush cleaning comb on the other edge of the spatula for scraping wet paint from a paint brush. One particular embodiment has two indentations on opposing edges that define two squeegees of different length: one for gallon-sized cans of paint and the other for quart-sized cans of paint.

### CROSS-REFERENCE TO RELATED APPLICATIONS

This application claims the benefit of the filing date of U.S. provisional application no. 63/049,730, filed on Jul. 9, 2020 as attorney docket no. 1387.001 PROV, the teachings of which are incorporated herein by reference in their entirety.

### BACKGROUND

### Field of the Disclosure

The present disclosure relates to paint supplies and, more specifically but not exclusively, to stirrers for cans of paint.

### Description of the Related Art

This section introduces aspects that may help facilitate a better understanding of the disclosure. Accordingly, the statements of this section are to be read in this light and are not to be understood as admissions about what is prior art or what is not prior art.

U.S. Pat. Nos. 4,884,895 and 5,494,352 and U.S. Patent Application Publication Nos. 2005/0018533, 2005/0030833, and 2007/0183255 describe various devices for stirring paint.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1A is a plan view of the front side of a paint stir spatula, according to one possible embodiment of this disclosure;

FIG. 1B is a plan view of the back side of the spatula of FIG. 1A;

FIGS. 1C and 1D are perspective views of the spatula of FIG. 1A;

FIG. 1E is a plan view of the front side of the spatula of FIG. 1A showing the dimensions of different features (in inches); and

FIG. 1F is a plan view of the front side of the spatula of FIG. 1A showing indicia according to one possible implementation of the spatula.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

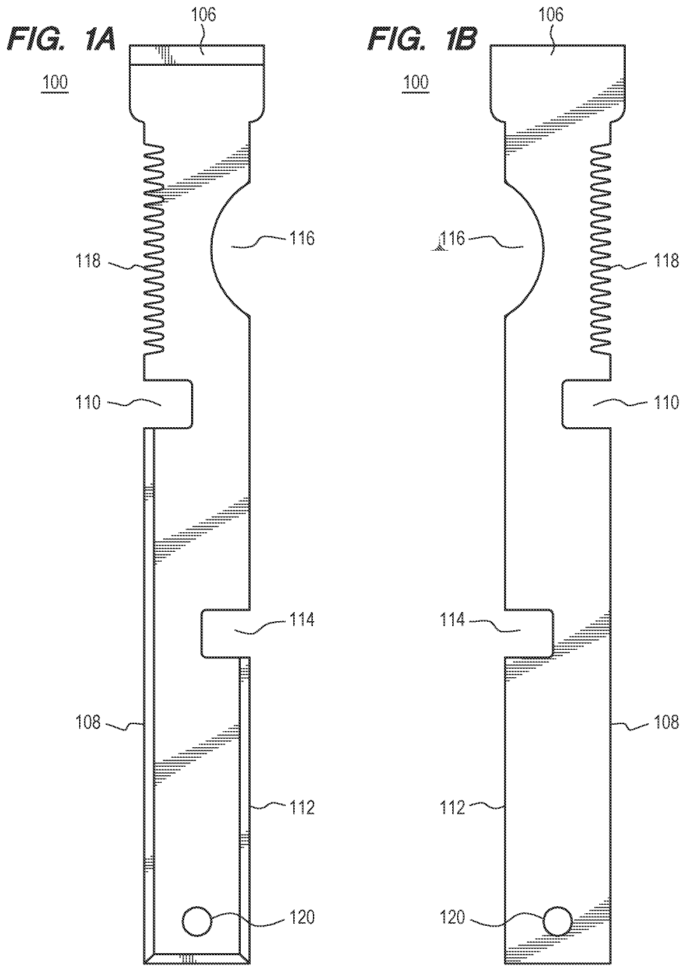

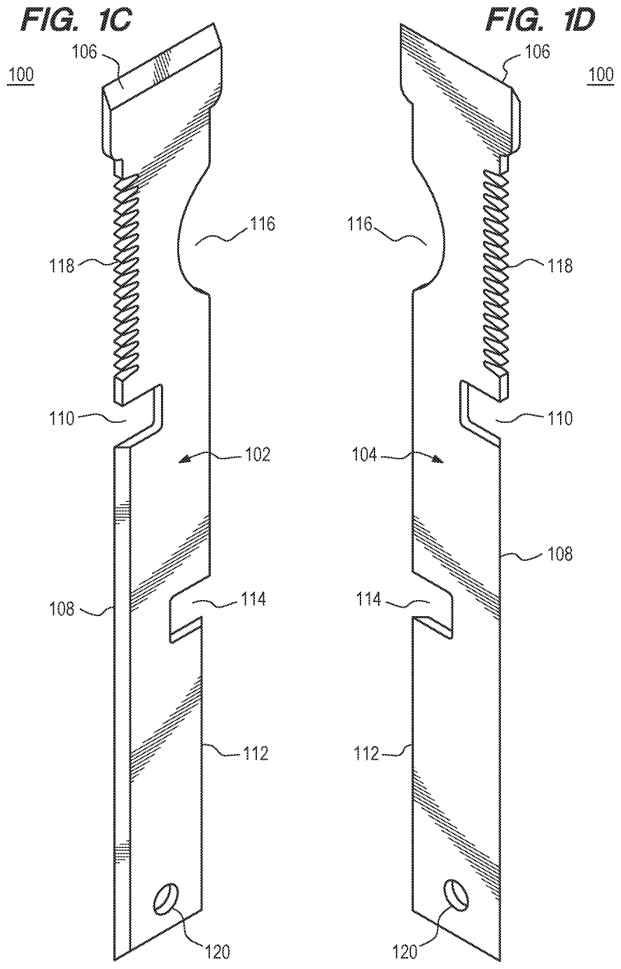

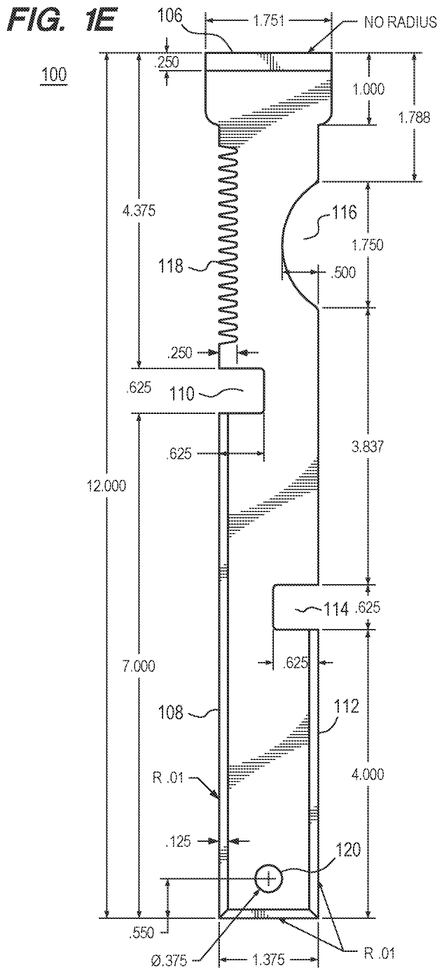

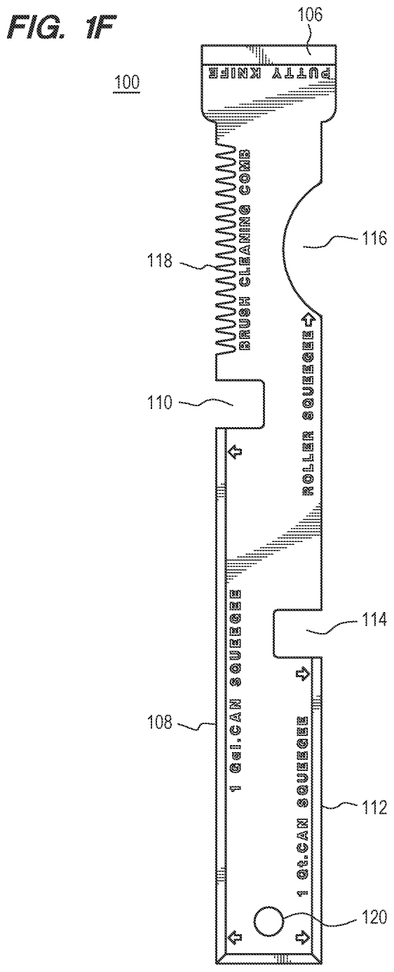

FIG. 1A is a plan view of the front side 102 of a paint stir spatula 100 that can be used manually to stir paint in a can of paint (not shown), according to one possible embodiment of this disclosure. FIG. 1B is a plan view of the back side 104 of the spatula 100 of FIG. 1A. FIGS. 1C and 1D are perspective views of the spatula 100 of FIG. 1A. FIG. 1E is a plan view of the front side 102 of the spatula 100 of FIG. 1A showing the dimensions of different features (in inches). FIG. 1F is a plan view of the front side 102 of the spatula 100 of FIG. 1A showing indicia according to one possible implementation of the spatula 100.

As shown in FIGS. 1A-1F, the spatula 100 has a putty knife end 106 that is beveled on the front side 102 and enables the spatula 100 to be used to apply spackle and/or other putty-like substances (not shown) to a surface. It also enables the spatula 100 to be used as a scraper for paint and other substances on a surface.

The spatula 100 has (i) a relatively long, straight squeegee side 108 that is beveled on the front side 102 and (ii) a first rectangular indentation 110 that enables the spatula 100 to be used to scrape paint from the inner wall of a standard 1-gallon can of paint (not shown), where the rim at the top of the paint can fits within the indentation 110.

Similarly, the spatula 100 has a relatively short, straight squeegee side 112 that is beveled on the front side 102 and a second rectangular indentation 114 that enables the spatula 100 to be used to scrape paint from the inner wall of a standard 1-quart can of paint (not shown), where the rim at the top of the paint can fits within the indentation 110.

The spatula 100 has a curved, roller squeegee indentation 116 that enables the spatula 100 to scrape paint from a standard paint roller (not shown).

The spatula 100 has a serrated, brush cleaning comb 118 that enables the spatula 100 to scrape paint from a standard paint brush (not shown).

The spatula 100 has a hole 120 that enables the spatula 100 to be hung from a hook, for example, for display purposes in a store and/or for storage purposes in a home workshop. The hole 120 also aids in the mixing of paint when the corresponding end of the spatula 200 is inserted into a can of paint.

The spatula 100 can be made of any suitable materials including a plastic such as, without limitation, high-density polyethylene (HDPE), acrylonitrile butadiene styrene (ABS), or nylon, and can be manufactured using any suitable technique such as injection molding.

Although paint stir spatulas have been described in the context of the specific embodiment of FIGS. 1A-1F, those skilled in the art will understand that the disclosure also includes embodiments having one or more dimensions and/or indicia that differ from the dimensions and/or indicia of that specific embodiment. For example, in alternative embodiments, the indentations 110 and 114 may be swapped such that (i) the relatively long, straight squeegee 108 is on the edge with the curved, roller squeegee indentation 116 and (ii) the relatively short, straight squeegee 112 is on the edge with the serrated, brush cleaning comb 118. Furthermore, the hole 120 can be near the other end of the spatula. Furthermore, some embodiments may have only one squeegee on either the edge with the curved, roller squeegee indentation 116 or the edge with the serrated, brush cleaning comb 118.

In certain embodiments, the present disclosure is a paint stir spatula (e.g., 100) having length, width, and thickness, wherein the length is greater than the width and the width is greater than the thickness such that the spatula has relatively short first and second ends and relatively long first and second edges. The first end of the spatula is a beveled putty knife end (e.g., 106) of the spatula; the first edge of the spatula has a first indentation (e.g., 110) that defines a straight, first squeegee (e.g., 108) between the first indentation and the second end of the spatula; and a curved, roller squeegee indentation (e.g., 116) and a serrated, brush cleaning comb (e.g., 118) are respectively located on opposing edges of the spatula.

In at least some of the above embodiments, the second edge of the spatula has a second indentation (e.g., 114) that defines a straight, second squeegee (e.g., 112) between the second indentation and the second end of the spatula.

In at least some of the above embodiments, the first edge of the spatula is beveled along the first squeegee; and the second edge of the spatula is beveled along the second squeegee.

In at least some of the above embodiments, the width and depth of the first indentation and the distance between the first indentation and the second end of the spatula enable the first squeegee to scrape paint from the inner wall of a gallon can of paint when the first indentation receives the inner rim of the gallon can of paint; and the width and depth of the first indentation and the distance between the second indentation and the second end of the spatula enable the second squeegee to scrape paint from the inner wall of a quart can of paint when the second indentation receives the inner rim of the quart can of paint.

In at least some of the above embodiments, the distance between the first indentation and the second end of the spatula is about 7 inches; and the distance between the second indentation and the second end of the spatula is about 4 inches.

In at least some of the above embodiments, the widths and depths of the first and second indentations are about 0.625 inches.

In at least some of the above embodiments, the serrated, brush cleaning comb is located on the first edge of the spatula; and the curved, roller squeegee indentation is located on the second edge of the spatula.

In at least some of the above embodiments, the putty knife end of the spatula is wider than the second end of the spatula.

In at least some of the above embodiments, a hole (e.g., 120) is located near the second end of the spatula.

In at least some of the above embodiments, the paint stir spatula is plastic.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this disclosure may be made by those skilled in the art without departing from embodiments of the disclosure encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A paint stir spatula (e.g., 100) having length, width, and thickness, wherein the length is greater than the width and the width is greater than the thickness such that the spatula has relatively short first and second ends and relatively long first and second edges, wherein:
the first end of the spatula is a beveled putty knife end (e.g., 106) of the spatula;
the first edge of the spatula has a first indentation (e.g., 110) that defines a straight, first squeegee (e.g., 108) between the first indentation and the second end of the spatula; and
a curved, roller squeegee indentation (e.g., 116) and a serrated, brush cleaning comb (e.g., 118) are respectively located on opposing edges of the spatula.

2. The paint stir spatula of claim 1, wherein the second edge of the spatula has a second indentation (e.g., 114) that defines a straight, second squeegee (e.g., 112) between the second indentation and the second end of the spatula.

3. The paint stir spatula of claim 2, wherein:
the first edge of the spatula is beveled along the first squeegee; and
the second edge of the spatula is beveled along the second squeegee.

4. The paint stir spatula of claim 2, wherein:
the width and depth of the first indentation and the distance between the first indentation and the second end of the spatula enable the first squeegee to scrape paint from the inner wall of a gallon can of paint when the first indentation receives the inner rim of the gallon can of paint; and
the width and depth of the first indentation and the distance between the second indentation and the second end of the spatula enable the second squeegee to scrape paint from the inner wall of a quart can of paint when the second indentation receives the inner rim of the quart can of paint.

5. The paint stir spatula of claim 4, wherein:
the distance between the first indentation and the second end of the spatula is about 7 inches; and
the distance between the second indentation and the second end of the spatula is about 4 inches.

6. The paint stir spatula of claim 5, wherein the widths and depths of the first and second indentations are about 0.625 inches.

7. The paint stir spatula of claim 1, wherein:
the serrated, brush cleaning comb is located on the first edge of the spatula; and
the curved, roller squeegee indentation is located on the second edge of the spatula.

8. The paint stir spatula of claim 1, wherein the putty knife end of the spatula is wider than the second end of the spatula.

9. The paint stir spatula of claim 1, wherein a hole (e.g., 120) is located near the second end of the spatula.

10. The paint stir spatula of claim 1, wherein the paint stir spatula is plastic.

11. The paint stir spatula of claim 1, wherein:
the second edge of the spatula has a second indentation (e.g., 114) that defines a straight, second squeegee (e.g., 112) between the second indentation and the second end of the spatula;
the first edge of the spatula is beveled along the first squeegee;
the second edge of the spatula is beveled along the second squeegee;
the width and depth of the first indentation and the distance between the first indentation and the second end of the spatula enable the first squeegee to scrape paint from the inner wall of a gallon can of paint when the first indentation receives the inner rim of the gallon can of paint;
the width and depth of the first indentation and the distance between the second indentation and the second end of the spatula enable the second squeegee to scrape paint from the inner wall of a quart can of paint when the second indentation receives the inner rim of the quart can of paint;
the serrated, brush cleaning comb is located on the first edge of the spatula;
the curved, roller squeegee indentation is located on the second edge of the spatula;
the putty knife end of the spatula is wider than the second end of the spatula;
a hole (e.g., 120) is located near the second end of the spatula; and
the paint stir spatula is plastic.

12. The paint stir spatula of claim 11, wherein:
the distance between the first indentation and the second end of the spatula is about 7 inches;
the distance between the second indentation and the second end of the spatula is about 4 inches; and
the widths and depths of the first and second indentations are about 0.625 inches.
